(19) United States
(12) Patent Application Publication
(10) Pub. No.: US 2014/0045088 A1
(43) Pub. Date: Feb. 13, 2014

(54) FUEL CELL, THE OVERALL SIZE OF WHICH IS REDUCED

(71) Applicants: Delphine Drouhault, St Egreve (FR); Pierre Nivelon, Saint Hilaire Du Touvet (FR)

(72) Inventors: Delphine Drouhault, St Egreve (FR); Pierre Nivelon, Saint Hilaire Du Touvet (FR)

(73) Assignee: Commissariat a l'energie atomique et aux ene alt, Paris (FR)

(21) Appl. No.: 14/114,053

(22) PCT Filed: Apr. 26, 2012
(86) PCT No.: PCT/EP2012/057620

§ 371 Date: Oct. 25, 2013

(30) Foreign Application Priority Data
Apr. 27, 2011 (FR) 11 53607

(51) Int. Cl. H01M 8/04

(52) U.S. Cl. CPC H01M 8/04074
USPC 429/435

(57) ABSTRACT

A fuel cell including two stacks of electrochemical cells, a thermal management system including a coolant circulation circuit in the stacks, each stack of electrochemical cells being squeezed by a first end plate common to the two stacks and a second end plate, each stack including at least one coolant circulation channel, two pumps being provided for circulating the coolant in the channels, and a chamber formed in the common end plate, the two pumps and the channels passing through the stacks being connected to this chamber. There are valves between each pump and the chamber, communication with a pump being interrupted if there is no coolant flow from this pump.

### TECHNICAL DOMAIN AND PRIOR ART

This invention relates to a fuel cell, the overall size of which is reduced.

A fuel cell is powered with a combustible gas, for example hydrogen in the case of a cell of the Proton Exchange Membrane Fuel Cell (PEMFC) type, and a gas oxidising fuel, for example air or oxygen, to generate electricity. Another effect of operation of the fuel cell is to generate thermal energy.

A fuel cell comprises one or several stacks of electrochemical cells, and each cell comprises an anode and a cathode. Cells are kept in contact with each other by terminal plates connected by tie rods.

A circuit is provided to supply the cells with reactive gases.

Furthermore, the electrochemical efficiency of the cell is dependent on the temperature within the cell and this is due to the nature of the materials used. The operating temperature is usually less than 80° C. in order to achieve the best electrochemical efficiency. Cooling is achieved by circulation of a coolant inside the stack, the coolant itself being cooled outside the cell. A pump circulates the coolant flow inside the stack in particular, and in the circuit in general. The pump is sized as a function of the thermal power to be evacuated and also as a function of pressure losses within the circuit.

For cells with high electrical powers of the order of several tens of kilowatts, several stacks of connected bipolar plates are made which optimises the efficiency of the cell by making it operate at an operating point close to 0.7 V/cell. This configuration with several stacks can also limit the total height and pressure losses in the distribution of coolants and reactive fluids.

In the case in which a cell comprises several stacks, the cooling circuits in each of the stacks are supplied in parallel, and the coolant is circulated in the different cooling circuits by means of a pump.

Therefore this pump is chosen to be powerful enough to circulate coolant in all the stacks so as to extract the heat from all the stacks. Consequently, the pump is relatively large in the case of a high power cell with a large number of electrochemical cells, while the objective in general is to reduce the size of the fuel cell, particularly in onboard applications. Furthermore, if this pump fails, cooling is no longer possible in any of the stacks.

### PRESENTATION OF THE INVENTION

Consequently, one purpose of this invention is to provide a fuel cell in which the heat exchange system is reliable and compact compared with fuel cells according to the state of the art.

In the case of a cell with several stacks, the purpose mentioned above is achieved by a fuel cell comprising several stacks of cells compressed between two end plates, at least one of the end plates being common to the two stacks, and at least one thermal management circuit. This circuit comprises channels passing through each stack. Each channel is connected to a common chamber formed in an end plate, said chamber being supplied by several pumps. Means are also provided to interrupt communication between each of the pumps and the chamber. If all the pumps are in operation, all channels are supplied with the coolant from the chamber supplied by the pumps. If one of the pumps stops, its communication with the chamber is interrupted, and the coolant supply in all stacks is maintained by the pumps remaining in operation.

In the case of a fuel cell comprising a single stack, the purpose stated above is also achieved by a chamber formed in one of the end plates, the chamber being connected to several channels passing through the single stack and pumps supplying the chamber which itself outputs the coolant to the channels. All channels are supplied with coolant even if one of the pumps stops. Means are also provided to prevent the coolant from discharging into the stopped pump.

Very advantageously, these backflow protection means are formed by valves controlled directly by the presence or absence of the coolant flow.

In other words, one of the end plates comprises a coolant redistribution chamber equalising the pressure in the various cooling circuits and maintaining cooling in all stacks or in the entire stack.

The subject-matter of this invention is then a fuel cell comprising at least two stacks of electrochemical cells, a thermal management system composed of a coolant circulation circuit in the stacks and a system to supply cells with reactive gases, each stack of electrochemical cells being squeezed by a first end plate common to the two stacks and a second end plate, the common end plate being located on the upstream side of the electrochemical cells, along the direction of circulation of the coolant,

said thermal management system comprising:
in each stack, at least one coolant circulation channel;
at least two pumps for circulating the coolant in the channels,
a chamber formed in the common end plate, the at least two pumps and the channels passing through the stacks being connected to the chamber, said chamber being interposed between the pumps and the channels passing through the stacks, and
means of interrupting communication between each pump and the chamber, communication with a pump being interrupted if there is no coolant flow from this pump.

Another subject-matter of this invention is a fuel cell comprising a stack of electrochemical cells and first and second end plates applying a squeezing force on the electrochemical cells, a thermal management system formed from a system to circulate coolant in the stack and a system for supplying reactive gases to the stack, the first end plate being located on the upstream side of the cells along the direction of circulation of the coolant,

said thermal management system comprising:
at least two channels passing through the stack and opening up on the other side;
at least two coolant circulation pumps;
a chamber formed in the first end plate and connected to the channels passing through the stack and to the pumps, said chamber being interposed between the channels and the pumps; and
means of interrupting communication between each pump and the chamber, communication with a pump being interrupted if there is no coolant flow from this pump.

Advantageously, the interruption means are formed by valves for each pump, each valve comprising a closer that will bear in contact with a valve seat formed by the contour of the connection orifice between the chamber and a pump if there is no coolant flow. The valve preferably comprises a guide rod fixed to the closer and perpendicular to it. The valve may also comprise elastic return means of the closer, bearing in contact with the valve seat.

The fuel cell may comprise one coolant circulation pump for each stack.

The fuel cell may also comprise means of stopping each pump independently of the other pump(s), to reduce electricity consumption.

The fuel cell advantageously comprises means of controlling the pumps, the number of pumps brought into operation depending on the operating power demand from the cell.

The fuel cell may comprise electrochemical cells of the proton exchange membrane type.

### BRIEF DESCRIPTION OF THE DRAWINGS

This invention will be better understood after reading the following description and the appended drawings on which:

FIG. 1 is a longitudinal sectional view at an end plate of an example embodiment of a fuel cell according to this invention in a state in which the two pumps are operating;

FIG. 2 is a sectional view similar to that in FIG. 1, in the case in which one of the pumps is stopped;

FIG. 3 is a longitudinal sectional view of a variant embodiment of a fuel cell according to this invention;

FIG. 4 is a perspective view of an example embodiment of a fuel cell according to this invention comprising two stacks of cells;

FIG. 5 is a longitudinal sectional view of an example embodiment of a fuel cell according to this invention comprising a single stack of cells.

### DETAILED PRESENTATION OF PARTICULAR EMBODIMENTS

An example embodiment of a fuel cell to which this invention could be applied is shown in FIG. 4.

The fuel cell comprises two stacks C1, C2 of electrochemical cells.

Each stack C1, C2 comprises bipolar plates and ion exchange membranes arranged alternately. Two end plates 2, 4 connected by tie rods apply a compression force to the bipolar cells to achieve electrical conduction uniformly distributed over the entire area of the elements forming the cells.

In the example shown, one of the end plates 2 is common to the two stacks while the other end plate 4 is distinct for each stack. As a variant, it could be envisaged that the two end plates 2, 4 are common for the two stacks C1, C2.

The cell also comprises circuits to supply cells with reactive gases, for example one supplying hydrogen and the other supplying air or oxygen.

The cell also comprises a thermal management system 12 formed by a coolant circulation circuit inside the stacks to exchange heat with the cells, and a circulation circuit (not shown) located outside the stack.

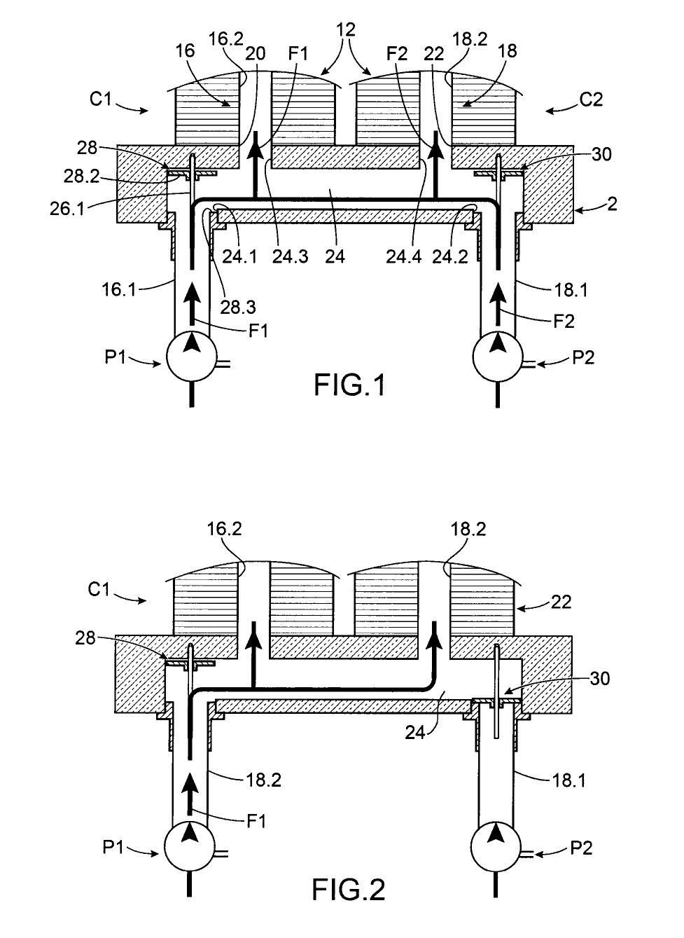

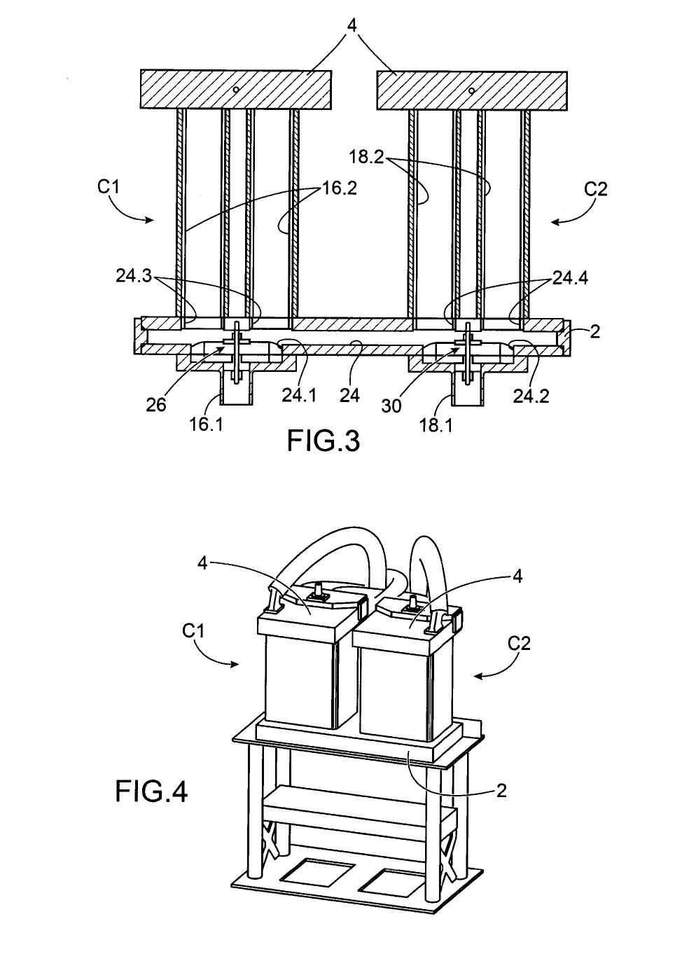

FIG. 1 shows a cell sectional view according to this invention at the lower end plate, through which the coolant enters the cells. The coolant is a fluid with a low electrical conductivity and typically deionised water, to which some additive(s) may be added, for example monoethylene glycol, to lower its freezing point, or corrosion inhibiting nanoparticles.

The thermal management system comprises a circulation circuit 16, 18 in each stack formed from at least one channel passing longitudinally through the stack C1, C2. Each channel comprises an inlet end 20, 22 connected to the “cold” coolant supply and an end (not shown) through which the coolant heated when passing through the stack is evacuated.

In the example shown, each stack comprises its own coolant circulation pump P1, P2 inside the circuit.

Pumps P1, P2 are located on the upstream side of the stacks C1, C2 along the coolant circulation direction.

The pumps are usually of the rotating centrifugal (or axial) type. These pumps have the advantage that they can control a continuous fluid flow with low discharge pressures, since the coolant circuit is not usually pressurized.

The thermal management system comprises a chamber 24 at the inlet to the stack formed in the first end plate 2 forming a pressure equalising chamber between the two circulation circuits 16, 18. Therefore, the chamber is inserted between the pumps P1, P2 and the stacks C1, C2.

Each circulation circuit 16, 18 comprises an upstream portion 16.1, 18.1 opening up into the chamber 24 through inlet orifices 24.1, 24.2 and connecting the pumps to the chamber 24, and downstream portions between the chamber 24 and the stacks C1, C2, and connected to the chamber 24 through outlet orifices 24.3, 24.4.

In FIG. 1, coolant circulations in stacks C1, C2 are symbolised by arrows F1 and F2, these circulations being driven by pumps P1 and P2.

The chamber 24 also comprises means of closing one of the inlet orifices 24.1, 24.2 so as to prevent circulation of coolant from one of the upstream portions 16.1, 18.1 to the other upstream portion 18.1, 16.1 through chamber 24 if one of the pumps fails to operate.

Very advantageously and as shown in FIGS. 1 and 2, the closing means are formed from valves 28, 30 installed at each of the inlet orifices 24.1, 24.2.

Preferably, the two valves are similar. We will only describe one valve in detail.

The valve 28 comprises a closer 28.1 mounted on a rod 28.2 perpendicular to the closer and coaxial to the inlet orifice 24.1 and providing axial guidance for the valve in the inlet orifice 24.1. The valve comprises a valve seat 28.3 formed by the contour of the inlet orifice 24.1. The valves have the advantage that they are simple to make, reliable and operate independently, and they close and open automatically in the absence or presence respectively of coolant flow circulation.

In the example shown, the valves are of the gravity type, i.e. they come into contact with their valve seat under the effect of their weight if there is no coolant flow. In one embodiment in which the valves are not of the gravity type, for example if part of the chamber 24 is near the top of the stacks or if the axis of the stacks is horizontal, return means are provided for example of the helical spring type mounted in compression, bringing the closer back into contact with its seat if there is no coolant flow. The spring may be installed between the closer and the wall of the chamber opposite the wall in which the inlet orifices are located, or in a spring cage fixed relative to the closer.

As a variant, it would be possible for example to provide means controlled from the exterior, for example solenoid valves. If one of the pumps fails to operate, the corresponding solenoid valve is controlled in close.

FIG. 4 shows a variant practical embodiment of a cell according to this invention in which each circulation circuit comprises at least two channels passing longitudinally through the stacks. Chamber 24 then comprises a pair of outlet orifices 24.3, 24.4 connected to the upstream portions of the circulation circuits.

Each stack may comprise more than two channels, the chamber then comprises one outlet orifice for each channel.

We will now explain operation of the thermal management system according to this invention.

Normal operation in this description is considered as being operation during which all pumps are operating, i.e. the two pumps P1 and P2 in the example shown.

Degraded operation corresponds to the case in which one of the two pumps is not operating, either because it is in failure, or because it has been deliberately stopped, for example to reduce the electricity consumption.

During normal operation, the two pumps P1, P2 operate. Each pump P1, P2 circulates coolant in the upstream portion 16.1, 18.1 towards the downstream portion 16.2, 18.2 through the chamber 24. This circulation is represented by arrows F1, F2. The valves are in the open position, the closers being kept in the position separated from their valve seat. The coolant circulating in each of the upstream portions is mixed in the chamber 24, which equalises the coolant pressure. The coolant is then distributed between the two downstream portions 16.2, 18.2.

During degraded operation, for example pump P2 does not operate. Consequently, there is no coolant circulation in the upstream portion 18.1 of the circuit 18. Due to the lack of circulation and force of gravity, the closer bears in contact with the valve seat, and the valve is then closed.

Simultaneously, pump P1 continues to operate, causing circulation of the coolant in the upstream portion 16.1 of the circuit 16 towards the downstream portion 16.2 through chamber 24, the valve being open. Since pump P1 supplies chamber 24 with coolant, the coolant is then distributed between the two downstream portions 16.2, 18.2. Furthermore, since the valve 30 is closed, this valve prevents coolant from the upstream portion 16.1 from flowing towards the upstream portion 18.1. Pump P1 alone then circulates coolant in the two stacks.

If one of the two pumps stops unexpectedly, maintaining a cooling flow through all stacks in the cell can delay the temperature rise in one of the stacks and therefore help to detect the failure before equipment is damaged. Means are advantageously provided to indicate that one of the pumps is not operating, for example means of detecting the lack of flow in one of the upstream portions or means of measuring the electrical current consumed by the pump.

For comparison, we will now give an example of the sizing of a thermal management system according to this invention comprising two stacks and two pumps, and a thermal management system with a single pump according to the state of the art.

The specification to be satisfied by the fuel cell is as follows:

electrical power supply demand 30 kW,

evacuated thermal power 30 kW,

thermal capacity of the coolant liquid equal to 3000 J/kg/K, for example 50% Monoethylene glycol with a density of 1021 kg/m³,

temperature difference between the fuel cell inlet and outlet equal to 10° C.,

estimated pressure loss in the exchanger equal to 100 mbar,

estimated pressure loss in the remaining part of the circuit equal to about 100 mbar, the remaining part of the circuit being composed of thermovalves to manage circulation of the coolant as a function of its temperature, and pipe inlet and outlet orifices.

The circulation flow is Qm=0.98 litres/second namely about 60 l/min, for a theoretical cell efficiency equal to 50%.

Therefore, the pump must output a discharge pressure equal to at least 350 mbar at 60 l/min.

These conditions according to the invention can be satisfied using two centrifugal pumps operating at 30 l/min. Compact plastic centrifugal pumps can be used at these flows. For example, two Johnson C090® pumps installed in parallel satisfy the above conditions.

The dimensions of each pump are then depth 24 cm, width 12 cm and height 15 cm. The mass of such a pump is 3 kg.

In the case of a conventional circuit comprising a single pump, a Lutz-Jesco® centrifugal pump reference BN80-50-200 can be used, with dimensions which are depth 60 cm, width 26 cm and height 36 cm for a mass of 60 kg, to satisfy the above specifications.

Therefore, it is found that according to the invention, the dimensions of the coolant circulation means in the cell are significantly reduced and the mass reduction is very large, since it is divided by 10.

Concerning valves, for the example cell given above, the passage diameter may be 28 mm, giving a cross-sectional passage of 0.000632 m².

For a circulation flow equal to 30 l/min, corresponding to 1.8 m³/h, the valve has a maximum mass of 40 g. For example, maximum thickness of a stainless steel closer with a diameter of 28 mm is 8.2 mm.

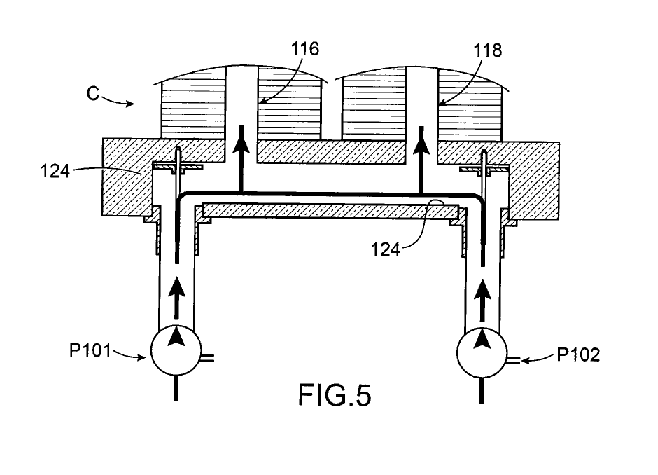

This invention is also very advantageously applicable to a fuel cell with a single stack C, as shown in FIG. 5.

The cell can operate at several powers and therefore release different heat quantities depending on its power in operation. For example, distinct channels 116, 118 connected at the inlet to chamber 124 itself connected to several pumps P101, P102, pass through the single stack.

It is then possible to get all pumps P101, P102 to operate when the cell operates at maximum power and reduce the number of pumps in operation depending on the power. The electrical consumption may then be adapted as a function of the heat quantity to be evacuated. Furthermore, this avoids having a single pump sized for permanent operation at high power, whereas such a flow is not necessary.

Furthermore, as mentioned above, when one of the pumps is no longer operating, evacuation of heat is maintained and the cell can continue to operate even in degraded mode, while if the single pump fails in cells according to the state of the art, the cell must be stopped otherwise the stack will be damaged.

Furthermore, on-off operation pumps can also be used, since they are simpler to manufacture.

A fuel cell with different numbers of stacks and pumps is within the scope of this invention, and a fuel cell with several pumps and channels passing through the single stack is also within the scope of this invention.

The invention does not increase the size because it is entirely integrated into one of the end plates, and it comprises few additional elements when compared with a cell according to the state of the art. Only valves have been added and chamber 24 has been made in the end plate. Consequently, it is easy to use and it can be easily adapted to existing cell structures.

The invention simplifies integration of the thermal management system into the cell because it uses several small and lightweight pumps that can more easily be integrated into the cell system. Furthermore, safety of the different stacks is maintained if one of the circulation pumps fails. Furthermore, with the invention, one or several cooling pumps can be taken out of service if the cell has to operate at low output, for example in order to save electrical energy.

1-8. (canceled)

9. A fuel cell comprising:
at least two stacks of electrochemical cells;
a thermal management system comprising a coolant circulation circuit in the stacks; and
a system to supply cells with reactive gases;
each stack of electrochemical cells being squeezed by a first end plate common to the two stacks and a second end plate, the common end plate being located on an upstream side of the electrochemical cells, along a direction of circulation of the coolant;
the thermal management system comprising:
in each stack at least one coolant circulation channel,
at least two pumps for circulating the coolant in the channels,
a chamber formed in the common end plate, the at least two pumps and the channels passing through the stacks being connected to the chamber, the chamber being interposed between the pumps and the channels passing through the stacks, and
a stopper system for interrupting communication between each pump and the chamber, communication with a pump being interrupted if there is no coolant flow from this pump.

10. A fuel cell according to claim 9, in which the stopper system includes valves for each pump, each valve comprising a closer that will bear in contact with a valve seat formed by a contour of the connection orifice between the chamber and a pump if there is no coolant flow.

11. A fuel cell according to claim 10, in which each valve comprises a guide rod fixed to the closer and perpendicular to it.

12. A fuel cell according to claim 10, in which each valve comprises elastic return means of the closer, bearing in contact with the valve seat.

13. A fuel cell according to claim 9, wherein each pump can be stopped independently of each other pump.

14. A fuel cell according to claim 9, further comprising a controller for controlling the pumps, a number of pumps brought into operation depending on the operating power demand from the cell.

15. A fuel cell according to claim 9, comprising electrochemical cells of proton exchange membrane type.

16. A fuel cell comprising:
a stack of electrochemical cells and first and second end plates applying a squeezing force on the electrochemical cells;
a thermal management system formed from a system to circulate a coolant in the stack; and
a system for supplying reactive gases to the stack;
the first end plate being located on an upstream side of the cells along a direction of circulation of the coolant,
the thermal management system comprising:
at least two channels passing through the stack,
at least two coolant circulation pumps,
a chamber formed in the first end plate and connected to inputs to channels passing through the stack and to the pumps, the chamber being interposed between the channels and the pumps, and
a stopper system for interrupting communication between each pump and the chamber, communication with a pump being interrupted if there is no coolant flow from this pump.

17. A fuel cell according to claim 16, in which the stopper system comprises valves for each pump, each valve comprising a closer that will bear in contact with a valve seat formed by a contour of the connection orifice between the chamber and a pump if there is no coolant flow.

18. A fuel cell according to claim 17, in which each valve comprises a guide rod fixed to the closer and perpendicular to the closer.

19. A fuel cell according to claim 17, in which each valve comprises elastic return means of the closer, bearing in contact with the valve seat.

20. A fuel cell according to claim 16, wherein each pump can be stopped independently of each other pump.

21. A fuel cell according to claim 16, further comprising a controller for controlling the pumps, a number of pumps brought into operation depending on an operating power demand from the cell.

22. A fuel cell according to claim 16, comprising electrochemical cells of proton exchange membrane type.
